(19) United States
(12) Patent Application Publication
(10) Pub. No.: US 2005/0069234 A1
(43) Pub. Date: Mar. 31, 2005

(54) Motor with aerodynamic bearing

(76) Inventors: Takashi Kanai, Iruma-shi (JP); Kazuhiro Takada, Iruma-shi (JP); Hiroki Matsushita, Iruma-shi (JP)

Correspondence Address: JORDAN AND HAMBURG LLP, 122 EAST 42ND STREET, SUITE 4000, NEW YORK, NY, 10168, US

(21) Appl. No.: 10/673,780

(22) Filed: Sep. 29, 2003

(51) Int. Cl. H02K 5/16; F16C 32/06; H02K 1/22

(52) U.S. Cl. 384/112; 310/90; 310/266

(57) ABSTRACT

The motor with aerodynamic bearing constitutes so that the detrimental power added to the shaft and sleeve of the bearing does not act from the magnetic circuit generates torque, and the rigidity of the bearing becomes small; vibration resulting from radial anti-rigidity becomes small; the loss in iron hysteresis and over-current are lost; the magnetic vibration and sound are reduced remarkably; bearing loss becomes small; it can be rotated high-speed; and the energy loss is small.

### BACKGROUND OF THE INVENTION

This invention relates to a motor with aerodynamic bearing, being used for the color wheel motor, a fan motor, a coreless motor, etc. used for a color copier machine, a color printer, etc.

This kind of the conventional motor arranges a permanent magnet around the rotor and rolls the coil around the core in the stator side.

In the conventional motor with aerodynamic bearing, the radial power acts to the shaft and sleeve the magnetic power committed between the permanent magnet of the rotor and the core of the stator. Since this power becomes so large that it is equal to the rigidity which a aero bearing generates according to the setup, it must be made big bearing rigidity. The magnetic vibration and sound generated by the coil and core become large and loud, the energy for surfacing the bearing becomes also large, the loss becomes large, and the efficiency is bad.

### SUMMARY OF THE INVENTION

Accordingly, it is an object of the invention to provide a motor with aerodynamic bearing which constitutes so that the detrimental power added to the shaft and sleeve of the bearing does not act from the magnetic circuit generates torque, and the rigidity of the bearing becomes small; vibration resulting from radial anti-rigidity becomes small; the loss in iron hysteresis and over-current are lost; the magnetic vibration and sound are reduced remarkably; bearing loss is reduced; it can be rotated high-speed; and the energy loss is reduced.

Novel features which are believed to be characteristic of the invention, both as to its organization and method of operation, together with further objects and advantages thereof, are described below with reference to the accompanying drawings in which preferred embodiments of the invention are illustrated as an example.

It is to be expressly understood, however, that the drawings are for the purpose of illustration and description only, and are not intended as a definition of the limits of the invention.

### BRIEF DESCRIPTION OF THE DRAWINGS

FIG. 1 is a front view showing a first embodiment of the present invention;

FIG. 2 is a top view;

FIG. 3 is a cross sectional view taken along a line 3-3 of FIG. 1;

FIG. 4 is an exploded explanation view;

FIG. 5 is a cross sectional view taken along a line 5-5 of FIG. 1;

FIG. 6 is a cross sectional view showing a second embodiment of the present invention;

FIG. 7 is an exploded explanation view;

FIG. 8 is a cross sectional view showing a third embodiment of the present invention;

FIG. 9 is an exploded explanation view;

FIG. 10 is a cross sectional view showing a fourth embodiment of the present invention;

FIG. 11 is an exploded explanation view;

FIG. 12 is a cross sectional view showing a fifth embodiment of the present invention;

FIG. 13 is an exploded explanation view;

FIG. 14 is a cross sectional view showing a sixth embodiment of the present invention;

FIG. 15 is a cross sectional view showing a seventh embodiment of the present invention;

FIG. 16 is a cross sectional view showing an eighth embodiment of the present invention; and

FIG. 17 is a cross sectional view showing a ninth embodiment of the present invention.

### DETAILED DESCRIPTION OF THE PREFERRED EMBODIMENTS

Preferred embodiments of the present invention are described in more detail below with reference to the accompanying drawings.

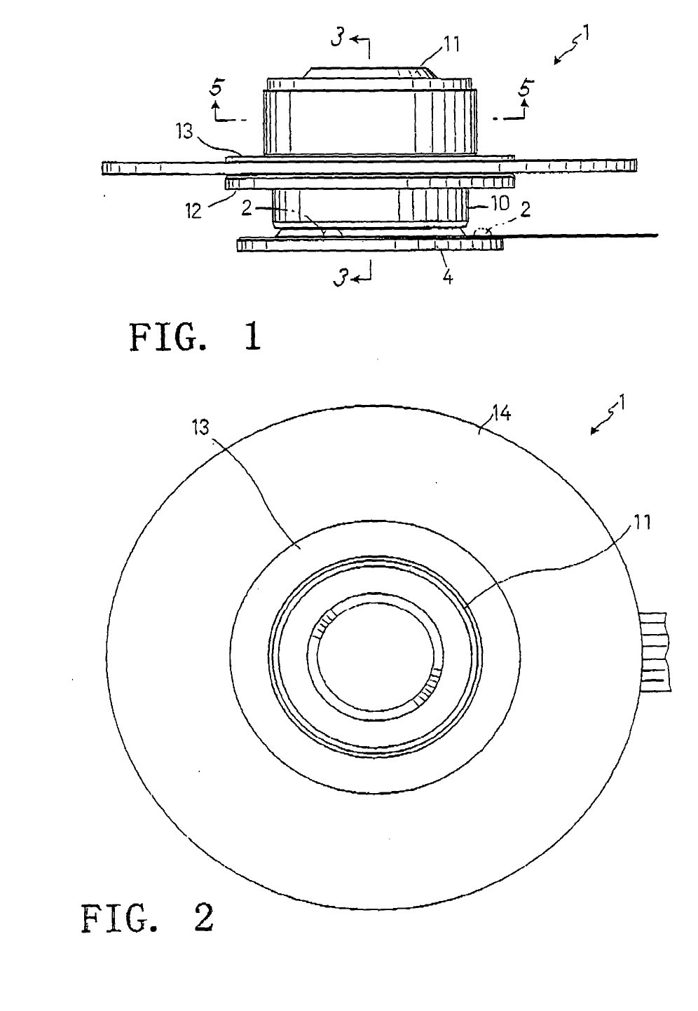

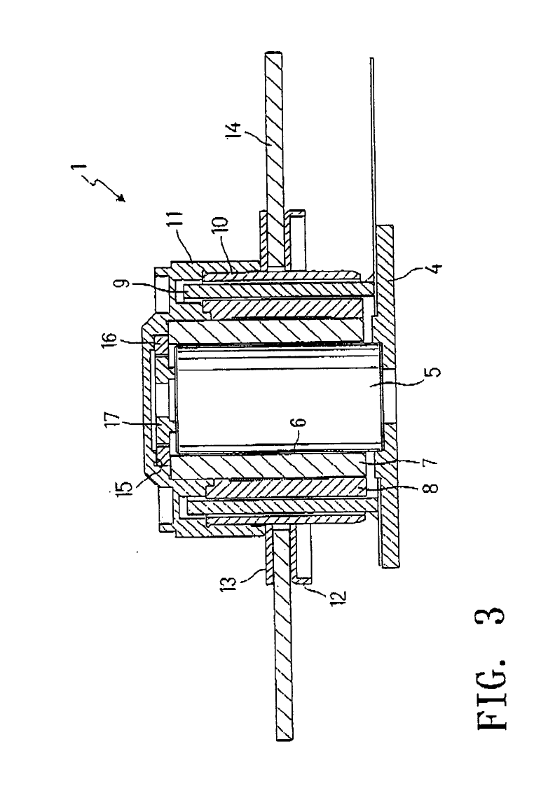

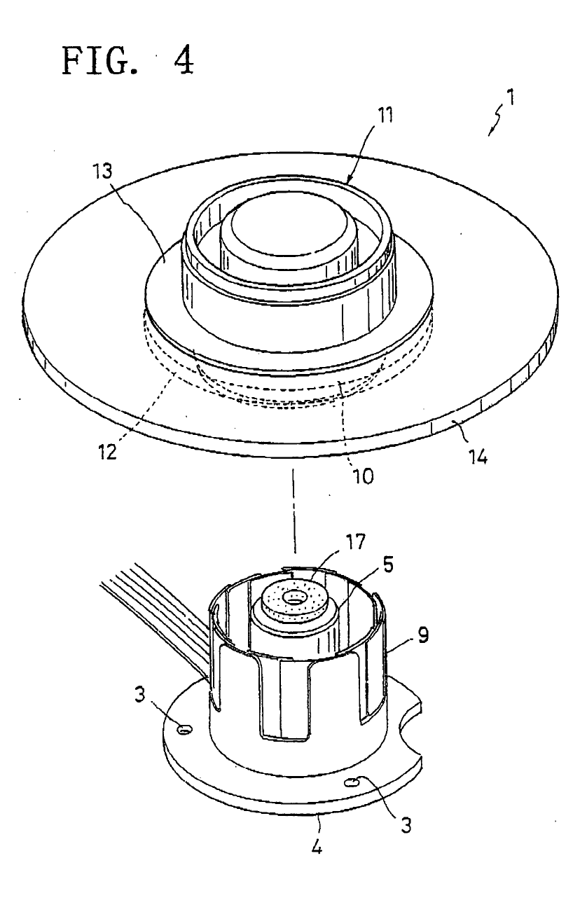

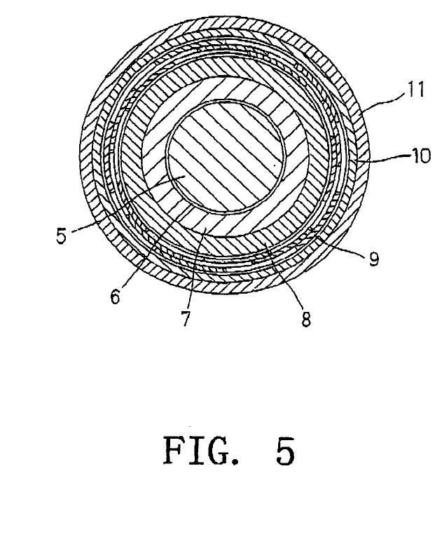

An understanding of the present invention may be best gained by reference to FIGS. 1-5.

The numeral 1 shows a motor with aerodynamic bearing of the present invention and is comprised of a base 4 having insertion holes 3, 3, 3 for a plurality of screws 2 for attachment formed at circumferential part thereof; a shaft 5 fixed so as to project from a part adjacent the central part of the base 4; a sleeve 7 arranged at the outer circumferential part of a shaft 5 through a gas space 6 which defines an aerodynamic bearing; a rotor 8 attached in the circumferential part of the sleeve 7, arranging the permanent magnet; a coreless waveform continuation coil 9, having triple rolling in this embodiment, attached in the base 4 in the fixation state so as to locate at the circumferential part of the rotor 8; a back yoke 10 attached so as to located at the circumferential part of the coreless waveform continuation coil 9; a hub 11 which supports fixedly the back yoke 10, sleeve 7 and rotor 8 and covers an upper part of the shaft 5; a color wheel 14 attached to the back yoke 10 by a cover 12 and a holder 13, projecting to the outer direction along the direction of the shaft center and right angle of the shaft 7; a thrust magnet 16, formed in the shape of a ring, fixed to a concave part 15 at the upper part of the hub 11; and a thrust magnet 17, located at upper and lower parts, fixed to the upper portion of the shaft 5 so as to work as a stopper which adsorbs to an inner part of the thrust magnet 16.

In the motor 1 of the present invention, the rotor 8 with the permanent magnet around the sleeve 7 arranged at the outer circumferential part of the shaft 5 via the gas space 6 is arranged, and also the coreless waveform continuation coil 9 is arranged so that the harmful power added to the shaft 5 and the sleeve 7 from the magnetic circuit that generates torque is gone.

Therefore, there should just be bearing rigidity which supports prudence of the rotor 8 basically.

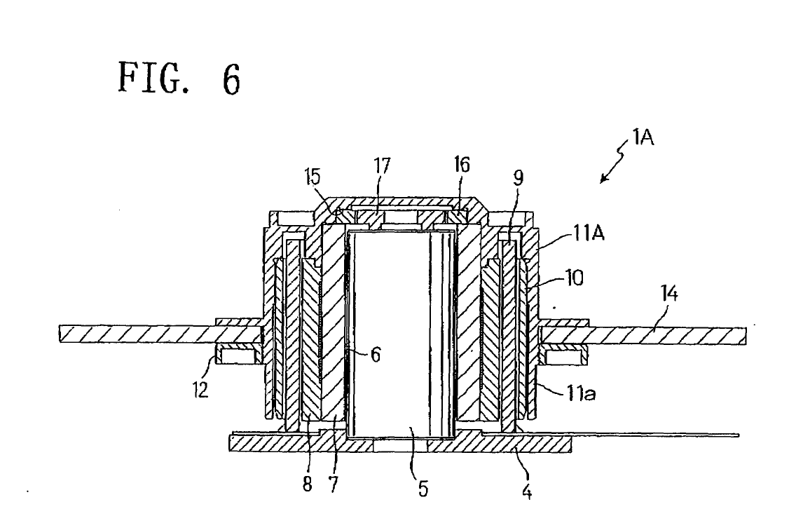

Other embodiments of the present invention will now be described with reference to FIGS. 6-17. In FIGS. 6-17, the same components as in the first embodiment described above with reference to FIGS. 6-17 are designated by the same reference numerals and therefore will not be further explained in great detail.

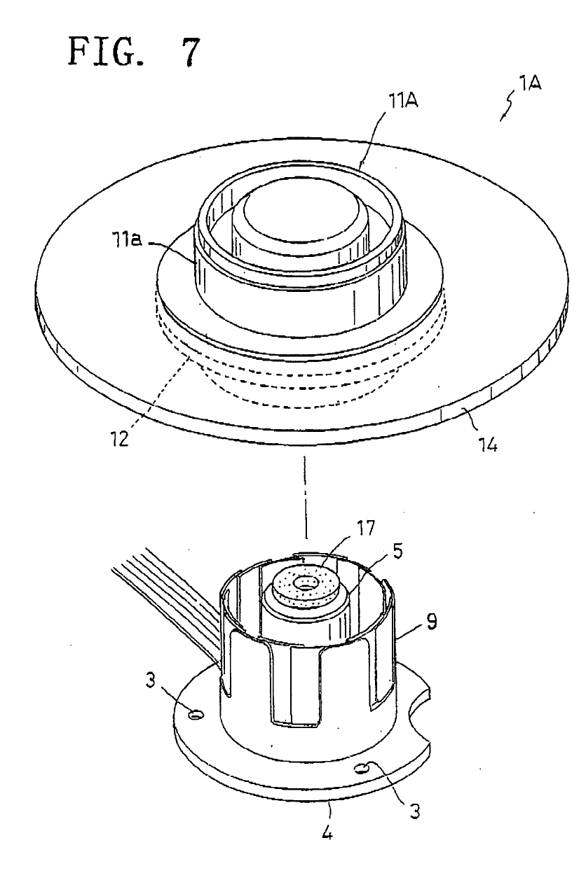

A second embodiment of the present invention is shown in FIGS. 6 and 7. It is distinguished from the first embodiment in that the outer circumferential part of the back yoke 10 is covered by a hub 11A, and a color wheel 14 is attached at the outer circumferential part of a sleeve member 11a of the hub 11A. A motor 1A according to the second embodiment has similar advantages to that according to the first embodiment.

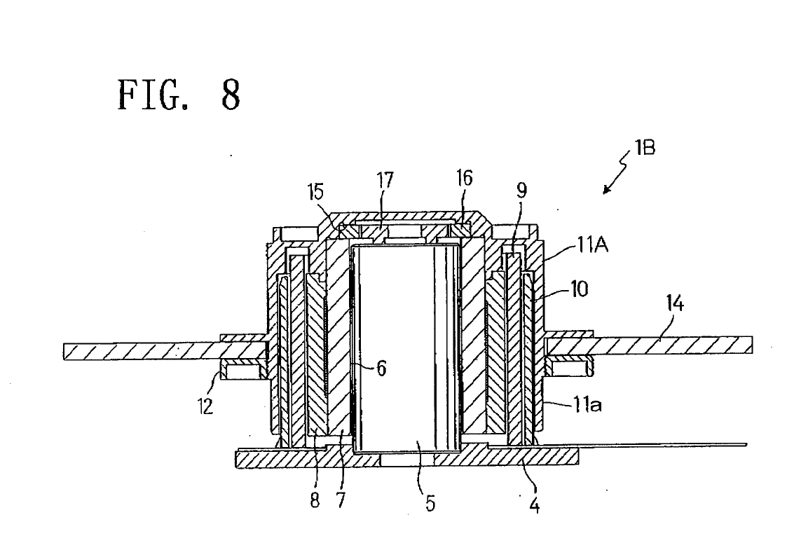

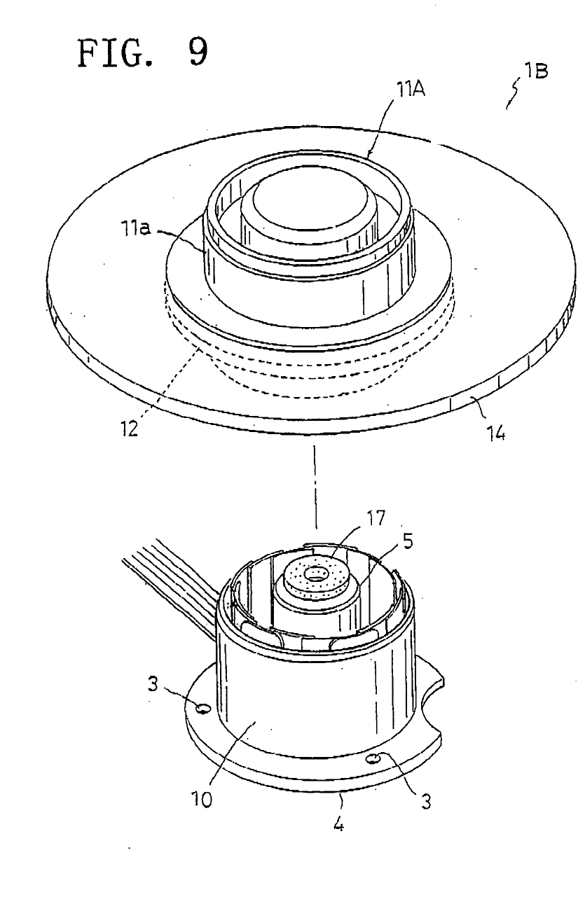

A third embodiment of the present invention is shown in FIGS. 8 and 9. It is distinguished from the second embodiment in that the back yoke 10 is fixed to the base 4. A motor 1B according to the third embodiment has similar advantages to that according to the second embodiment.

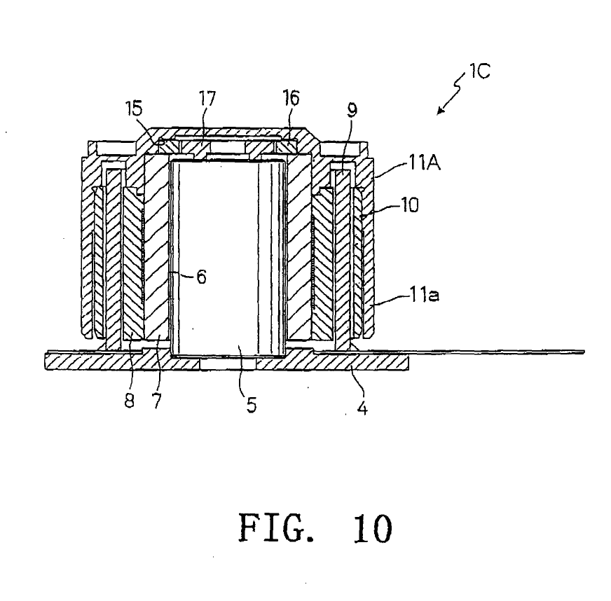

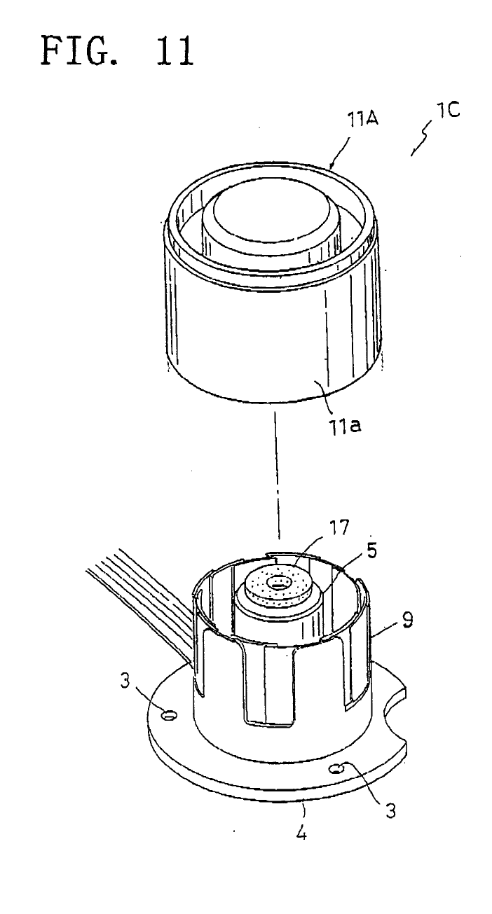

A fourth embodiment of the present invention is shown in FIGS. 10 and 11. It is distinguished from the second embodiment in that the sleeve member 11a of the hub 1A that cannot set the color wheel is used. A motor 1C without the color wheel according to the fourth embodiment has similar advantages to that according to the second embodiment.

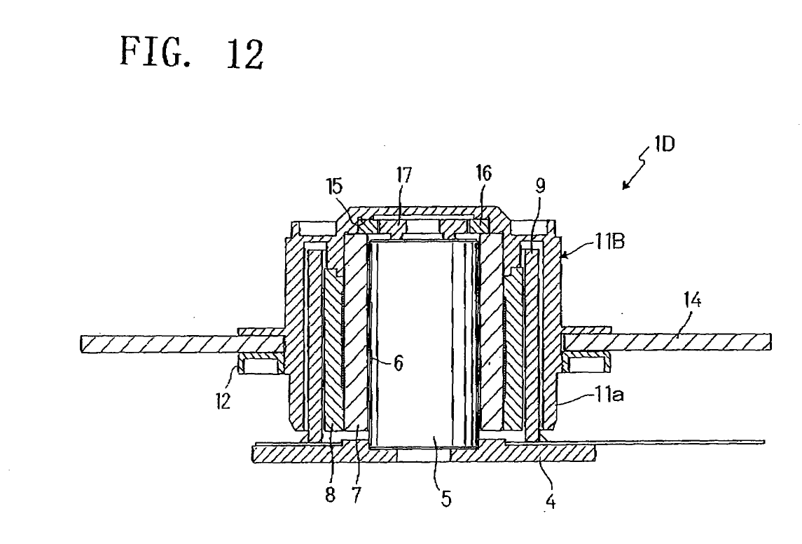

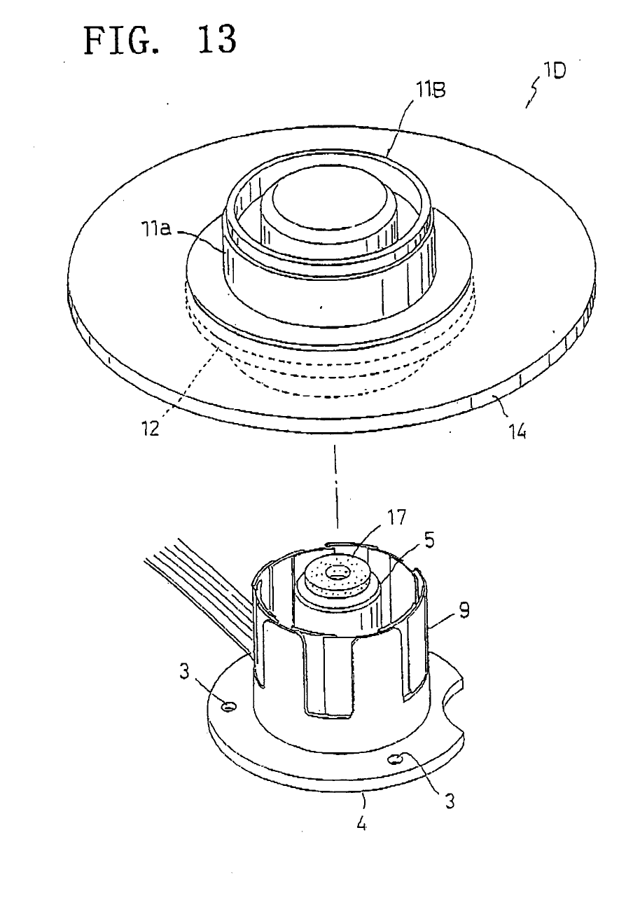

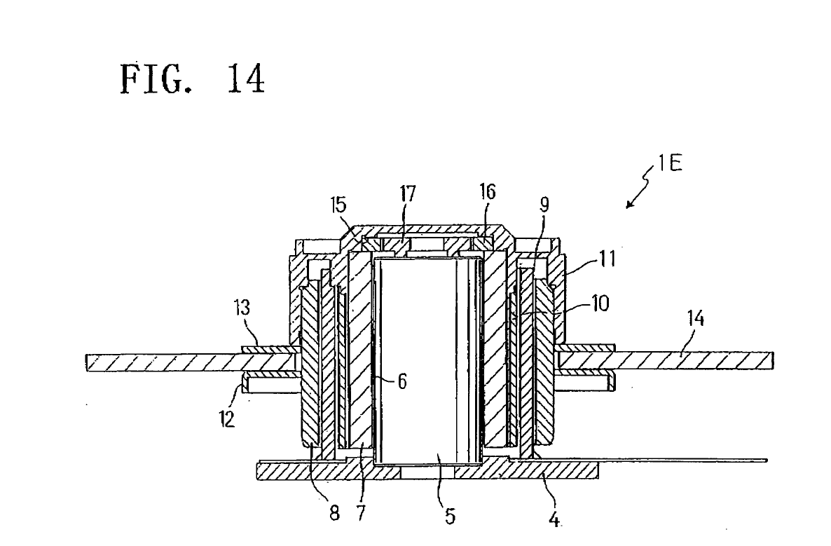

A fifth embodiment of the present invention is shown in FIGS. 12 and 13. It is distinguished from the second embodiment in that the sleeve member 11a of a hub 11B covers the outer circumferential part of the coreless waveform continuation coil 9. A motor 1D without the back yoke according to the fifth embodiment has similar advantages to that according to the second embodiment.

A sixth embodiment of the present invention is shown in FIG. 14. It is distinguished from the first embodiment in that the back yoke 10 is arranged at the outer circumferential part of the sleeve 7, and the rotor 8 with the permanent magnet provided at the outer circumferential part of the coreless waveform continuation coil 9. A motor 1E according to the sixth embodiment has similar advantages to that according to the first embodiment.

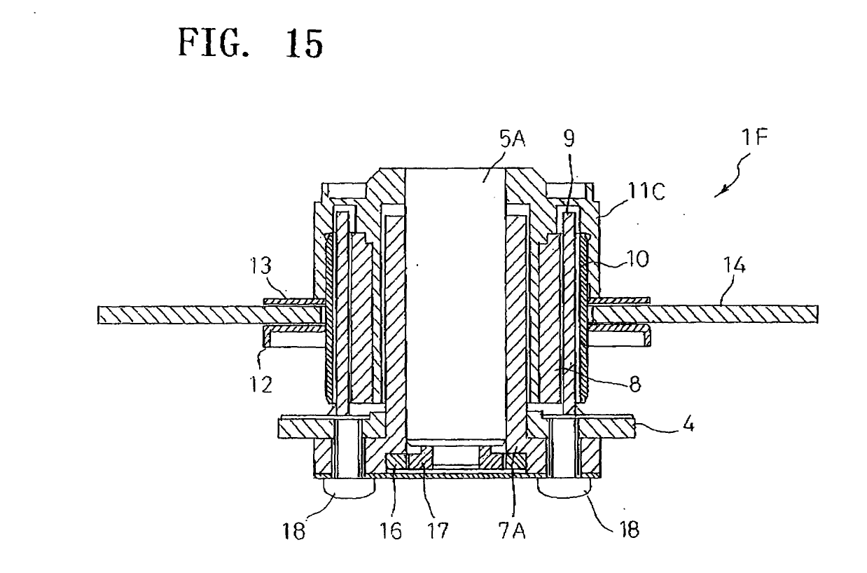

A seventh embodiment of the present invention is shown in FIG. 15. It is distinguished from the first embodiment in that a sleeve 7A is fixed to the base 4 by a plurality of screws 18 so as to project upward; a shaft 5A is arranged into the sleeve 7A via the gas space 6; and a hub 11C supports the shaft 5A, rotor 8 and back yoke 10 and covers the upper part of the sleeve 7A. A motor 1F according to the seventh embodiment has similar advantages to that according to the first embodiment

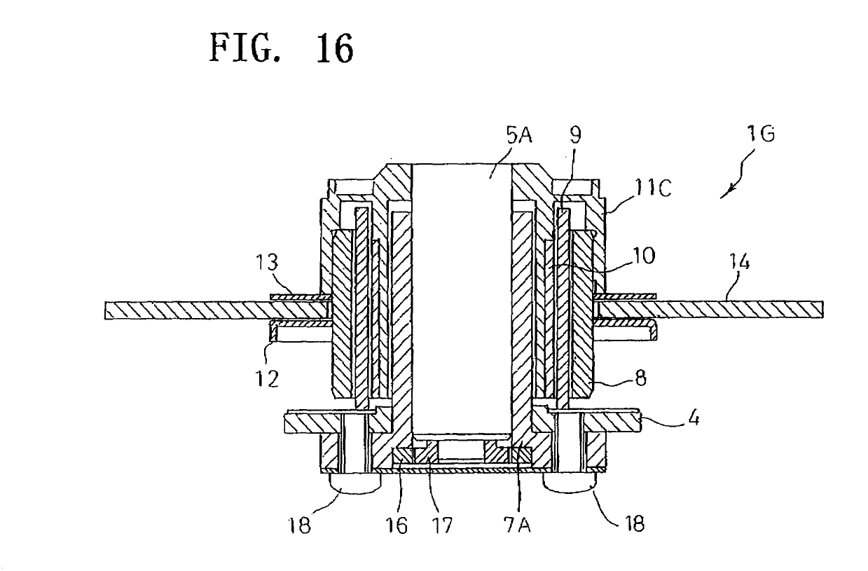

An eighth embodiment of the present invention is shown in FIG. 16. It is distinguished from the seventh embodiment in that the back yoke 10 is arranged at the outer circumferential part of the sleeve 7A, and the rotor 8 with the permanent magnet arranged at the outer circumferential part of the coreless waveform continuation coil 9. A motor 1G according to the eighth embodiment has similar advantages to that according to the seventh embodiment.

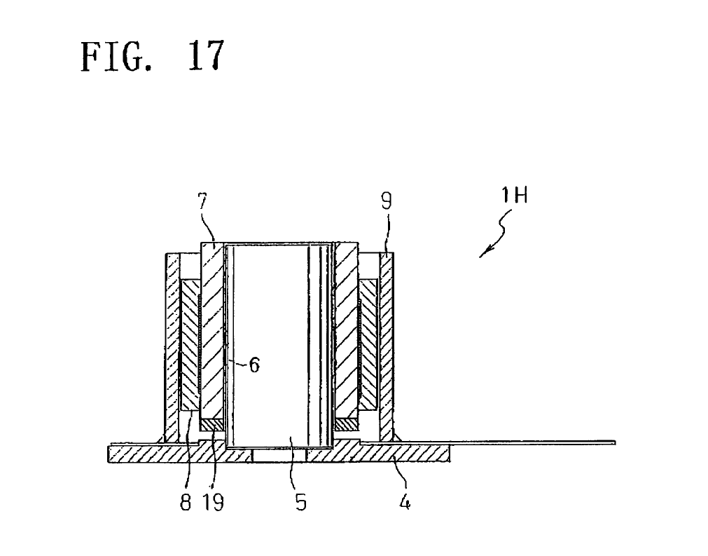

A ninth embodiment of the present invention is shown in FIG. 17. It is distinguished from the first embodiment in that a thrust washer 19 is provided at a lower end portion of the sleeve 7 without the hub and back yoke. A motor 1H according to the ninth embodiment may be used.

Moreover, instead of the thrust washer 19 in each embodiment, the magnet that repels each other may be provided at the corresponding part of the base 4 to the lower end portion of the sleeve 7.

In addition, the coreless waveform continuation coil 9 as a coil is used in each embodiment, and the coils other than the coreless waveform continuation coil 9 may be used in the present invention.

As set forth above, the advantages of the invention are as follows:

(1) The motor with aerodynamic bearing comprised of a base; a shaft fixed such that the shaft projects upward from a part adjacent a central portion of the base; a sleeve arranged at an outer circumferential part of the shaft via a gas space; a rotor provided at an outer circumferential part of the sleeve, arranging permanent magnets; and a coil provided at the base such that the coil locates around an outer circumferential part of the rotor. Therefore, it can omit the detrimental power added to the shaft and sleeve of the bearing from the magnetic circuit generates torque.

Therefore, the rigidity of the bearing can be small; vibration resulting from radial anti-rigidity can be small; it can be rotated high-speed; it can excel in durability; and it achieves at low noise.

(2) As discussed above, the loss in iron hysteresis and over-current can be reduced.

Therefore, the effect of reduction of loss is acquired.

(3) As discussed above, since the bearing rigidity can be small, energy for surfacing the bearing can be lessened.

Therefore, the bearing loss can be reduced and it can be done efficiently.

(4) As discussed above, when the ripple of the detent torque to the rotation direction is completely lost, and generating of the vibration and sound can be lost

(5) As discussed above, also claims 2, 3, 4 and 5 are acquired with the same action and effect as the above (1) to (4).

1. A motor with aerodynamic bearing comprising:
a base;
a shaft fixed such that the shaft projects upward from a part adjacent a central portion of the base;
a sleeve arranged at an outer circumferential part of the shaft via a gas space;
a rotor provided at an outer circumferential part of the sleeve, arranging permanent magnets; and
a coil provided at the base such that the coil locates around an outer circumferential part of the rotor.

2. A motor with aerodynamic bearing comprising:
a base;
a shaft fixed such that the shaft projects upward from a part adjacent a central portion of the base;
a sleeve arranged at an outer circumferential part of the shaft via a gas space;
a coil provided at the base such that the coil locates around an outer circumferential part of the sleeve;
a rotor provided at an outer circumferential part of the coil, arranging permanent magnets; and
a hub supports the sleeve and the rotor and covers an upper portion of the shaft such that the coil locates around an outer circumferential part of the rotor.

3. A motor with aerodynamic bearing comprising:
a base;
a sleeve fixed such that the sleeve projects upward from a part adjacent a central portion of the base;
a shaft arranged into the sleeve via a gas space;
a rotor provided at an outer circumferential part of the sleeve, arranging permanent magnets; and
a coil provided at the base such that the coil locates around an outer circumferential part of the rotor.

4. A motor with aerodynamic bearing according to claim 1, further comprising:
a hub supports the sleeve and the rotor and covers an upper portion of the shaft; and
a back yoke attached to the hub such that the back yoke locates around an outer circumferential part of the coil.

5. A motor with aerodynamic bearing according to claim 1, further comprising:
the coil which is a coreless waveform continuation coil;
a back yoke provided such that the back yoke locates around an outer circumferential part of the coreless waveform continuation coil;
a hub supports the sleeve, rotor and back yoke and covers an upper portion of the shaft; and
a color wheel attached to one of the hub and back yoke, projecting outward along the direction of the shaft core and right angle of the shaft.
